(19) United States
(12) Patent Application Publication
(10) Pub. No.: US 2006/0275553 A1
(43) Pub. Date: Dec. 7, 2006

(54) Electrically conductive thermal barrier coatings capable for use in electrode discharge machining

(75) Inventor: Ramesh Subramanian, Oviedo, FL (US)

Correspondence Address: Siemens Corporation;Intellectual Property Department, 170 Wood Avenue South, Iselin, NJ, 08830, US

(73) Assignee: Siemens Westinghouse Power Corporation

(21) Appl. No.: 11/145,439

(22) Filed: Jun. 3, 2005

(51) Int. Cl. B05D 7/00

(52) U.S. Cl. 427/421.1

(57) ABSTRACT

A thermal barrier coating capable of being used in an electrode discharge machining process. The thermal barrier coating has an increased electrical conductivity, thereby permitting the coating to be used in an electrode discharge machining process. The electrical conductivity of the TBC may be increased by mixing graphite and/or another electrically-conductive polymer into the TBC. Alternatively, the TBC may be coated with graphite and/or another electrically-conductive polymer. In either instance, EDM is then used to form a cooling hole and then the remaining electrically conductive material is burned out. In another embodiment, the TBC may be made using an electrically conductive thermal barrier material, and then use EDM to form cooling holes or other forms in a turbine or other substrate.

### FIELD OF THE INVENTION

This invention is directed generally to coatings for substrates, and more particularly to thermal barrier coatings used on gas turbine components.

### BACKGROUND

Turbine component life and design depends significantly on cooling flow effectiveness on the airfoil surfaces. Application of coatings provides an additional oxidation and thermal protection to the components thus extending component life. However, application of coatings by a spray process causes restriction of cooling holes, typically known as cooling-hole coat down. This alters the cooling flows on the airfoil surface and therefore its effectiveness.

To overcome the cooling-hole coat-down, masking techniques may be utilized, where a polymer is placed within each hole manually by a syringe. The polymer is allowed to cure and harden. The spray process deposits the coatings and then the polymer is burnt out, to leave cooling holes with no coat down. This process is time-consuming and expensive due to the use of the syringe and the time needed for the polymer to cure and harden.

Another approach is to drill the components after coating (both deposition of the bond coat and thermal barrier coatings). This may be achieved by laser drilling. Laser drilling is known to leave a recast layer in the component surface that could result in crack initiation. Advanced cooling hole designs are now depending on fan-shaped (consisting of a metering hole and a diffuser) cooling holes and this requires improved laser drilling techniques, for example millisecond and microsecond pulsed lasers. This makes the process expensive and also dependent on a few expert vendor sources.

Accordingly, what is needed is a less expensive method for overcoming cooling hole coat-down. Also what is needed is an effective method for increasing the electrical conductivity of thermal barrier coatings to permit these coatings to be drilled by conventional electrode discharge machining processes. New cooling hole designs incorporate a diffuser section to the straight hole to increase cooling film attachment to the substrate. These diffuser sections get coated with the TBC and can influence cooling effectiveness. Also, if thicker TBCs are utilized for increased thermal insulation then the problems related to masking burn off during the coating process, followed by coat-down can cause additional issues regarding cooling film effectiveness. As such, it would also be beneficial to provide a method for forming these new cooling hole designs without the disadvantages associated with prior art methods.

### SUMMARY OF THE INVENTION

This present invention provides a thermal barrier coating capable of being used in an electrode discharge machining (EDM) process. The thermal barrier coating (TBC) has an increased electrical conductivity, thereby permitting the coating to be removed in selected portions, such as the formation of cooling holes, using EDM. The electrical conductivity of the TBC may be increased by mixing graphite and/or another electrically-conductive polymer into the TBC. Alternatively, the TBC may be coated with graphite and/or another electrically-conductive polymer. In either instance, EDM may then be used to form a cooling hole and then the remaining electrically conductive material is burned out. In another embodiment, the TBC may be made using an electrically conductive thermal barrier material, and then use EDM to form cooling holes or remove other portions of the TBC in a turbine or other substrate.

These and other embodiments are described in more detail below.

### BRIEF DESCRIPTION OF THE DRAWINGS

There are shown in the drawings, embodiments which are presently preferred, it being understood, however, that the invention is not limited to the precise arrangements and instrumentalities shown.

FIGS. 1A and 1B show the cross-section of current coat-down issues within cooling holes during deposition of a thermal barrier coating after cooling hole machining.

FIG. 2 shows a cross-section of a straight cooling hole made according to one embodiment of the present invention.

FIG. 3 shows a method of forming a cooling hole in a coated substrate according to another embodiment of the present invention.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of.”

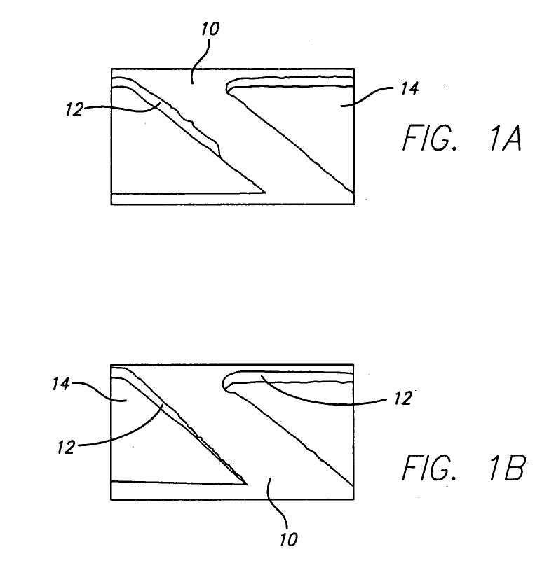

The present invention provides a thermal barrier coating for a substrate. The TBC is capable of being used in an electrode discharge machining process. The present invention provides an alternative cost-effective approach to overcome cooling-hole coat-down than prior art methods. As can be seen from FIGS. 1A and 1B, prior art methods of applying thermal barrier coatings result in cooling holes 10 that have coat-down 12, leaving cooling holes 10 that are not clean and/or smooth. As a result, these cooling holes are not as effective at cooling the turbine component. The coated substrates 14 shown in FIGS. 1A and 1B were formed using an air plasma spray coating of the TBC material on the turbine coating or other substrate.

Electrode discharge machining is a widely available technology for drilling both straight and fan shaped cooling holes. However, EDM of ceramic coated components is not possible since TBCs are not electrically conductive. Accordingly, the present invention increases the electrical conductivity of the TBC to permit for EDM of coated components and/or for maintaining the cooling-hole effectiveness.

Thermal barrier coatings (TBC) are layer systems deposited on metallic components, as for instance in gas turbines, to provide thermal insulation. The cooling of the components causes a pronounced reduction of the metal temperature, which leads to a prolongation of the mechanical component's lifetime. Alternatively, the use of thermal barrier coatings allows raising the firing temperature, obtaining thus an increased efficiency.

Thermal barrier coatings usually include two layers. The first layer, a metallic one, is the so-called bond coat, whose function is, on the one side, to protect the basic material against oxidation and corrosion and, on the other side, to provide with a good adhesion to the thermal insulating ceramic layer. However, as a result of the ceramic portion, the coating systems are not electrically conductive.

EDM is a method for producing holes and slots, or other shapes, by using an electric discharge (spark) to remove unwanted material. In an EDM process, metal is removed by generating high frequency sparks through a small gap filled with a dielectric fluid. This technique allows machining complicated shapes in hard metals, including refractory alloys.

The basic EDM process results in the movement of an electrode very close to the work piece, and repeatedly produces a spark between the two. In one embodiment, this is done while immersed in a dielectric liquid rather than in air. As a result, however, a necessary condition for EDM is that the material being removed must be electrically conductive.

Accordingly, EDM could be used to form cooling holes in turbine components. However, for those components having a thermal barrier coating, the coating had to be applied after the cooling holes had been formed, resulting in cooling-hole coat-down. The present invention alleviates these problems by forming an electrically-conductive TBC. As a result, the present invention permits cooling holes to be formed that are clean and do not suffer the problems associated with cooling-hole coat-down.

In a first aspect, the present invention provides a method for increasing the electrical conductivity of a TBC. This may be accomplished using a variety of different embodiments.

In one embodiment, the electrical conductivity of the TBC is increased by including a fugitive material in the coating. As used herein, a “fugitive” material is an electrically conductive material that is not intended to remain as part of the final TBC. The fugitive material is selected such that the TBC is electrically conductive such that the coating may be subjected to EDM. Then, after EDM, the fugitive material may be removed, such as by burning the material out from the coating.

In those embodiments using a fugitive material, the electrically conductive fugitive material is chosen such that it permits the TBC to be subjected to EDM. In one embodiment, the electrically conductive fugitive material is an electrically conductive polymer. Other examples of electrically conductive fugitive materials that may be used in the present invention include, but are not limited to, graphite, a conductive organic solution, or a combination thereof.

Spraying and Co-Spraying

There are several methods by which the fugitive material may be applied to the substrate. In one embodiment, the fugitive material may be mixed, as in a blend of the two materials, with the TBC coating material and then sprayed onto the substrate. In an alternative embodiment, the fugitive material may be co-sprayed or otherwise applied at the same time the TBC coating is applied. A “co-spraying” process is one wherein multiple components, such as the fugitive material and the TBC material, are applied at the same time.

In these spraying and co-spraying embodiments, the mixture of the TBC coating material and the fugitive material is applied using any known spraying or co-spraying technique. The mixture is applied to a substrate. The substrate may include a bond coat for helping to bond the TBC/fugitive mixture to the substrate. Then, the coated substrate is subjected to EDM to form the cooling hole or whatever other structure is selected to be formed. After EDM, the fugitive material may then be burned off.

The amount of electrically conductive fugitive material that is used in the TBC/fugitive mixture that is sprayed may be any amount sufficient to render the TBC electrically conductive. In one embodiment, the electrically conductive fugitive material is added in an amount to provide a total coating thickness of from about 50 to about 1000 μm.

Examples of fugitive electrically conductive polymers include, but are not limited to, polyaniline, polythiophene, polypyrrole, and polyacetylene. Other brand names of polymer materials with electrical conductivity that may be used in the present invention include Conductive Nylon 8715, Polyester Urethane 4931, Polyether Urethane 4901, and CoolPoly® E-Series polythiophene.

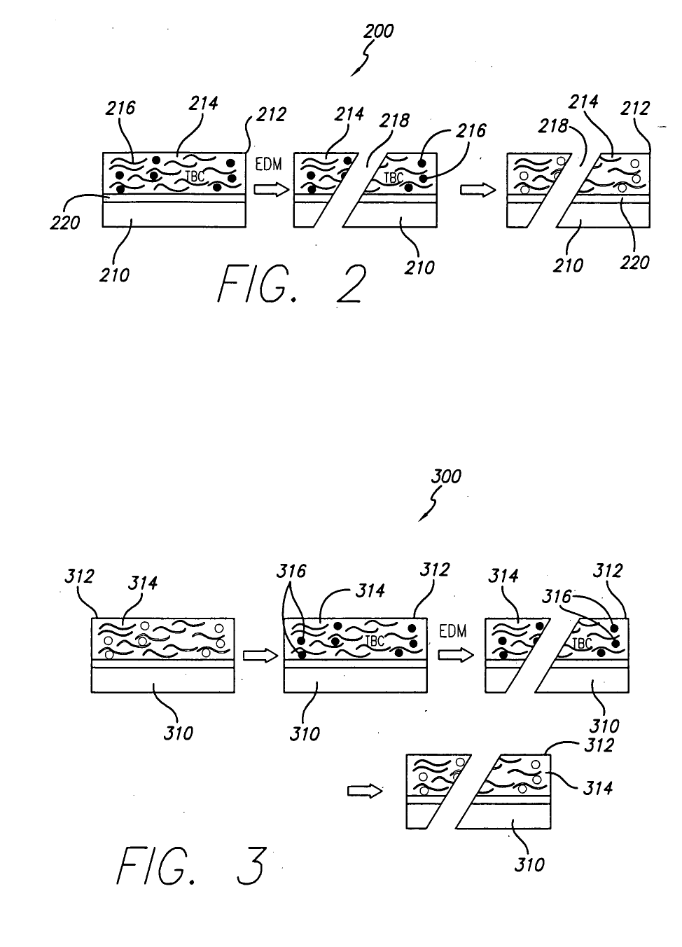

These spraying and co-spraying embodiments may be better seen in FIG. 2. FIG. 2 shows one embodiment of a spraying application 200. FIG. 2 provides a side view of a substrate 210 having a coating layer 212 including a thermal barrier coating material 214 and an electrically conductive polymer 216. A cooling hole 218 may be formed using EDM. In the embodiment shown in FIG. 2, the cooling hole is a typical straight cooling hole. After the cooling hole has been formed, the remainder of the electrically conductive polymer 216 may then be burned off or otherwise removed to leave a turbine component or other substrate having a cooling hole and a TBC with no cooling-hole coat-down. An optional bond coat 220 may also be used.

In an alternative embodiment, the present invention may provide a spraying or co-spraying process wherein a partially fugitive material is used instead of the fugitive material, or in addition to the fugitive material. In this embodiment, the partially fugitive material, such as a metallorganic solution, is mixed and then sprayed or co-sprayed in a manner similar to the application of graphite or other conductive organic solutions previously mentioned. However, when the fugitive material is burned off or otherwise removed, a metal film coating is left that coats the pores where the fugitive material had been. As a portion of the material remains, the metallorganic solution is partially-fugitive. This remnant metallic film would enable the EDM process to work through the electrically insulating ceramic material.

In addition to fugitive materials, the spraying and co-spraying methods of the present invention may also be used with non-fugitive materials that are capable of forming a TBC that is capable of being subjected to EDM. As with fugitive materials, the non-fugitive materials may be mixed with the TBC coating material and the resulting mixture may be applied using any known spraying or co-spraying technique. Again, once EDM had been performed, the remainder of the non-fugitive materials may be removed.

In still another alternative embodiment, the TBC may be made electrically conductivity through the use of a non-fugitive material that is electrically conductive. These electrically conductive TBC materials may also be applied using a spraying or co-spraying process as previously described to apply the mixture of the non-fugitive material and the thermal barrier coating material to a turbine component or other substrate. In this embodiment, the TBC is doped with appropriate metallic elements, such as Ni, Ti, Co, Zr, Y, or a combination thereof, to enhance the electrical conductivity. The TBC could also be doped by co-spraying ceramic oxides such as titanium dioxide, nickel oxide, cobalt oxide, iron oxide, transition metal oxides, metal oxides where the elements have a multivalent property, alkali and alkaline earth metals, rare earth oxides or a combination thereof. Then, the doped TBC is applied to the turbine component or other substrate. The doped TBC could also be a result of an intentional change in the ceramic oxide composition, with superior electrical conductivity. Next, the coated substrate is subjected to EDM to form the cooling holes. At that point, the remainder of the dopants may be oxidized, again leaving a turbine component or other substrate having a cooling hole and a TBC with no cooling-hole coat-down. In these embodiments, as the TBC is electrically conductive, no burn off or other process step is needed to burn off the excess electrically conductive polymer as with other embodiments using fugitive or partially-fugitive materials.

Infiltration

In lieu of spraying or co-spraying, the graphite or other electrically conductive material may be applied to the thermal barrier coating by infiltration of the electrically conductive material into the thermal barrier coating prior to EDM. In this embodiment, a solution may be applied locally, resulting in the infiltration of the conductive material. Infiltration could be aided by the application of vacuum to the whole part or locally. This is followed by EDM, leaving a cooling hole with no coat down.

Examples of electrically conductive fugitives were discussed earlier. These fugitives may be blended with carbon black or graphite and dispersed in a solution containing the polymer, such as polyamide. Control of the viscosity and graphite content is beneficial for optimum infiltration of an air plasma spray (APS) TBC microstructure.

The graphite powder may, in one embodiment, be fine, for example less than about 50-100 microns in size. Weight fractions of graphite may vary from as low as about 1 wt % to about 50 wt %. The addition of thinners, such as kerosene, may be used to improve the blend viscosity. Additional graphite powder application may also be used to aid in the initial generation of the spark for EDM through the insulating coating. Infiltration of all of the above electrically conductive combinations may be enhanced by application of vacuum or optimizing viscosity for easy infiltration.

In one embodiment of an infiltration method, the fugitive material is infiltrated into the TBC using a chemical vapor infiltration process. In an alternative embodiment, the fugitive material is infiltrated into the TBC by utilizing a solution based process. Examples of non-fugitive materials that may be used include, but are not limited to, zirconium, yttrium, nickel, ceramic materials, such as titanium dioxide, an electrically conductive oxide, or a combination thereof.

FIG. 3 provides an example of one embodiment of an infiltration method 300. As shown in FIG. 3, the TBC 310 is infiltrated or doped with an electrically conductive fugitive material or dopant 312. This results in a doped TBC on a turbine component 314 or other substrate. Next, the coated substrate is subjected to EDM 316 to form the cooling holes 318. At that point, the remainder of the electrically conductive polymer may be burned out or otherwise removed from the TBC, again leaving a turbine component or other substrate having a cooling hole and a TBC with no cooling-hole coat-down.

As with the spraying or co-spraying methods, the infiltration methods of the present invention may be used with partially-fugitive materials, such as metallorganic materials, or non-fugitive materials, such as Ni, Ti, Co, Zr, Y, or a combination thereof. As described previously, if a partially-fugitive material is used, then a subsequent burn off may be used to remove the fugitive portion of the material. However, if a non-fugitive material is used, no burn off step would be performed.

Combination

In another embodiment, a combination of the processes discussed above may be performed. In this embodiment, both a spraying process and an infiltration process may be used. For example, in one embodiment, this may include the steps of spraying blends or mixtures of electrically conductive material and TBC onto the substrate followed by infiltration with another electrically conductive material to further enhance the electrically conductivity.

While the present invention has been discussed in regards to increasing the electrical conductivity of thermal barrier coatings, it is to be understood that the present invention may be used to increase the electrical conductivity of other non-metallic materials. For example, after heat treatment of an article having no TBC, if an oxide layer has been formed on the surface of the substrate, the oxide layer may be made more conductive using any one of the processes previously discussed. As such, EDM may then be used to drill through or otherwise alter the shape of these non-TBC coated substrates.

The present invention may be used to make any thermal barrier coating electrically conductive, including those used on substrates other than turbine components. In addition, the EDM methods of the present invention may be used for other purposes than forming cooling holes. For example, the methods of the present invention may be used in processes to repair existing turbine components or other parts. While the present invention has been discussed regarding the formation of new parts, a service part already having cooling holes may, during a repair process, have on old TBC removed and replaced with a new TBC. As there are already cooling holes, the TBC will, in many instances, create a cooling-hole coat down after it has been applied. However, by using an electrically conductive TBC and EDM, the methods of the present invention can burn out the cooling hole coat down portions, thereby resulting in the repair of existing parts.

The foregoing is provided for purposes of illustrating, explaining, and describing embodiments of this invention. Modifications and adaptations to these embodiments will be apparent to those skilled in the art and may be made without departing from the scope or spirit of this invention. Additionally, it is to be understood that while the claims set forth process steps in a particular order, the methods of the present invention are not limited to this particular order such that any combination of these process steps that accomplishes one or more aspects of the present invention are to be considered within the scope of the present invention.

We claim:

1. A method for increasing electrical conductivity of a coating comprising the steps of:
forming a coating on a substrate using a coating material; and
integrating an electrically conductive material with the coating material;
wherein the electrically conductive material is integrated in an amount such that a portion of the coating is capable of being removed in an electrode discharge machining process.

2. The method of claim 1, wherein the coating material is a thermal barrier coating material.

3. The method of claim 1, wherein the electrically conductive material is integrated with the coating material by forming a mixture of the coating material and the electrically conductive material and then spraying the mixture onto the substrate.

4. The method of claim 1, wherein the electrically conductive material is integrated with the coating material by forming a mixture of the coating material and the electrically conductive material and then co-spraying the mixture onto the substrate.

5. The method of claim 1, wherein the electrically conductive material is integrated with the coating material by forming a coating of the coating material on the substrate and then infiltrating the coating material with the electrically conductive material.

6. The method of claim 5, wherein the electrically conductive material is infiltrated by applying a solution containing the electrically conductive material to the coating and then applying a vacuum such that infiltration of the conductive material into the coating occurs.

7. The method of claim 1, further comprising the step of electrode discharge machining a portion of the electrically conductive thermal barrier coating.

8. The method of claim 7, wherein the electrically conductive material includes a fugitive material.

9. The method of claim 8, further comprising the step of removing the fugitive material from the coating.

10. The method of claim 8, wherein the fugitive material is graphite.

11. The method of claim 7, wherein the electrically conductive material includes a partially-fugitive material.

12. The method of claim 11, further comprising the step of removing the fugitive portion of the electrically conductive material from the coating.

13. The method of claim 11, wherein the partially fugitive material is a metallorganic material.

14. The method of claim 7, wherein the electrically conductive polymer includes a non-fugitive material.

15. The method of claim 14, wherein the non-fugitive material is selected from Ni, Ti, Co, Zr, Y, or a combination thereof.

16. The method of claim 1, wherein the substrate is a turbine component.

17. A method for forming cooling holes in a turbine component comprising:
applying a thermal barrier coating material to the turbine component;
integrating an electrically conductive material into the thermal barrier coating material; and
electrode discharge machining at least one cooling hole in the turbine component.

18. The method of claim 17, wherein the cooling hole is a straight cooling hole.

19. The method of claim 17, wherein the cooling hole is a fan-type cooling hole.
